(19) United States
(12) Patent Application Publication
(10) Pub. No.: US 2022/0250314 A1
(43) Pub. Date: Aug. 11, 2022

(54) THREE-DIMENSIONAL PRINTING

(71) Applicant: Hewlett-Packard Development Company, L.P., Spring, TX (US)

(72) Inventors: Carolin Fleischmann, San Diego, CA (US); Emre Hiro Discekici, San Diego, CA (US); Shannon Rueben Woodfull, San Diego, CA (US); Stanley J Kozmiski, San Diego, CA (US)

(73) Assignee: Hewlett-Packard Development Company, L.P., Spring, TX (US)

(21) Appl. No.: 17/628,924

(22) PCT Filed: Sep. 18, 2019
(86) PCT No.: PCT/US2019/051730

§ 371 Date: Jan. 21, 2022

(51) Int. Cl. B29C 64/165; C09D 167/04; B33Y 10/00; B33Y 70/00

(52) U.S. Cl. CPC B29C 64/165; C09D 167/04; B29K 2067/046; B33Y 70/00; B33Y 10/00

(57) ABSTRACT

A three-dimensional (3D) printing kit includes a build material composition and a fusing agent. The build material composition includes biodegradable polyester particles having a volume-based particle size distribution including D10 ranging from about 65 μm to about 85 μm, D50 ranging from about 125 μm to about 145 μm, and D90 ranging from about 225 pm to about 245 μm. The fusing agent includes an energy absorber dissolved or dispersed in a liquid vehicle.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial coalescence of the build material, and the mechanism for material coalescence (e.g., curing, thermal merging/fusing, melting, sintering, etc.) may depend upon the type of build material used. For some materials, at least partial coalescence may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram depicting an example of a method for preparing a build material composition for a fusing agent based three-dimensional (3D) printing technique;

FIG. 2 is a flow diagram depicting an example of a 3D printing method; and

FIG. 3 is a schematic illustration of an example of a 3D printing method.

### DETAILED DESCRIPTION

Examples of the three-dimensional (3D) printing method disclosed herein utilize a fusing agent (including an energy absorber) to pattern a build material composition including biodegradable polyester particles. For this type of 3D printing process, it has been found that the particle size distribution of the biodegradable polyester particles should be at least substantially bimodal. By “at least substantially bimodal,” it is meant that the composition includes at least two differently sized biodegradable polyester particles, about 50% of which are larger and about 50% of which are smaller. In some examples, the particle size distribution is tri-modal. The larger particles of the build material composition aid in the creation of thin layers with well controlled uniformity to be formed during spreading; and the smaller particles aid in at least partially filling voids between the larger particles. Without the smaller particles, the melt coalescence may be undesirably slow. The at least bi-modal particle size distribution and the associated processing attributes during the 3D printing process lead to improved particle coalescence, which, in turn, leads to the formation of mechanically strong and aesthetically pleasing 3D printed objects. These 3D printed parts are also biodegradable, which enables them to be used in a variety of applications, such as food packaging, biomedical applications, etc.

Throughout this disclosure, a weight percentage that is referred to as “wt % active” refers to the loading of an active component of a dispersion or other formulation that is present in the fusing agent, detailing agent, coloring agent, etc. For example, a pigment may be present in a water-based formulation (e.g., a stock solution or dispersion) before being incorporated into the coloring agent. In this example, the wt % actives accounts for the loading (as a weight percent) of the pigment solids that are present in the coloring agent, and does not account for the weight of the other components (e.g., water, co-solvent(s), etc.) that are present in the stock solution or dispersion with the pigment. The term “wt %,” without the term actives, refers to either i) the loading (in the respective agent) of a 100% active component that does not include other non-active components therein, or ii) the loading (in the respective agent) of a material or component that is used “as is” and thus the wt % accounts for both active and non-active components.

Build Material Composition and Preparation Method

Disclosed herein is a build material composition that includes biodegradable polyester particles. The biodegradable polyester particles have a volume-based particle size distribution that has been found to be particularly suitable for the fusing agent based 3D printing process disclosed herein. The volume-based particle size distribution includes D10 ranging from about 65 μm to about 85 μm, D50 ranging from about 125 μm to about 145 μm, and D90 ranging from about 225 μm to about 245 μm. The particle size distribution is at least substantially bi-modal, which improves the coalescence of the particles during the 3D printing process. With this particle size distribution, the volume weighted mean diameter of the biodegradable polyester particles may range from about 25 μm to about 475 μm.

In an example, the biodegradable polyester particles are selected from the group consisting of polylactic acid, polyglycolide, poly(DL-lactide-co-glycolide), polyethylene succinate, polybutylene succinate, polybutylene adipate, polybutylene succinate/adipate copolymer, polycaprolactone, and combinations thereof. It is to be understood that copolymers of these biodegradable polyesters (block copolymers, graft copolymers, etc.) and/or cross-linked systems of the biodegradable polyesters may also be used.

The biodegradable polyester particles do not substantially absorb radiation having a wavelength within the range of 400 nm to 1400 nm. In other examples, the biodegradable polyester particles do not substantially absorb radiation having a wavelength within the range of 800 nm to 1400 nm. In these examples, the biodegradable polyester may be considered to reflect the wavelengths at which the biodegradable polyester does not substantially absorb radiation. The phrase “do or does not substantially absorb” means that the absorptivity of the biodegradable polyester at a particular wavelength is 25% or less (e.g., 20%, 10%, 5%, etc.).

Biodegradable polyesters are commercially available, often in the form of pellets. The present inventors have found that by grinding these materials, the particle size distribution can be obtained, which is particularly suitable for the 3D printing process disclosed herein. Moreover, the thermal properties of the ground particles are compatible with the 3D printing process disclosed herein. Still further, the high temperatures of the build area platform and the build material supply allow for the ground material to recrystallize before and during the printing process. As such, the ground material may have a higher crystalline content, which allows for more selective coalescence.

In addition to the biodegradable polyester particles, the build material composition includes a flow aid. The flow aid improves the coating flowability of the biodegradable polyester particles, and enables the biodegradable polyester particles to be spread into thin, substantially uniform layers. The flow aid improves the flowability of the biodegradable polyester particles by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), fused metal oxide (e.g., the AEROXIDE® series, available from Evonik) calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based upon the total weight of the build material composition. As one example, the build material composition includes from greater than 95 wt % to less than 100 wt % of the biodegradable polyester particles and from greater than 0 wt % to less than 5 wt % of the flow aid. In another example, the build material composition includes from about 0.05 wt % to about 1.5 wt % of the flow aid.

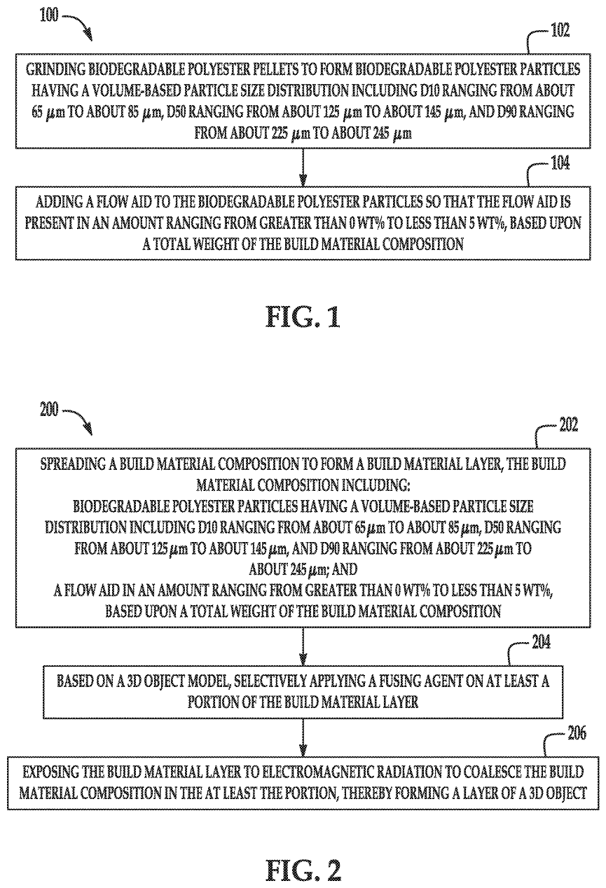

FIG. 1 shows an example of a method 100 for preparing a build material composition for a fusing agent based 3D printing techniques. The method 100 includes grinding biodegradable polyester pellets to form biodegradable polyester particles having a volume-based particle size distribution including D10 ranging from about 65 μm to about 85 μm, D50 ranging from about 125 μm to about 145 μm, and D90 ranging from about 225 μm to about 245 μm (reference numeral 102); and adding a flow aid to the biodegradable polyester particles so that the flow aid is present in an amount ranging from greater than 0 wt % to less than 5 wt %, based upon a total weight of the build material composition (reference numeral 104).

Grinding may be accomplished using any suitable grinder (e.g., an attritor, a ball mill, etc.), with or without grinding media (e.g., ceramic grinding beads). Some examples of the method 100 include monitoring the volume-based particle size distribution throughout the grinding process, and then stopping the grinding once the desired particle size distribution is achieved.

As a result of the grinding performed in the method 100, the biodegradable polyester particles have an at least substantially bimodal particle size distribution that is particularly suitable for a 3D printing method that utilizes a fusing agent.

Once the biodegradable polyester particles are formed, they may be mixed with the flow aid. Any suitable conditions may be used to mix the biodegradable polyester particles with the flow aid. As examples, mixing may be accomplished in a rotating container, using a mechanical mixer, or using a hand mixer. Mixing may also be accomplished at ambient temperatures, which may range from about 18° C. to about 25° C. During mixing, the flow aid particles can stick to the surface of the biodegradable polyester particles and improve the flowability of the biodegradable polyester particles, and thus the overall build material composition.

In addition to the biodegradable polyester particles and the flow aid, the build material composition may also include an antioxidant, a whitener, an antistatic agent, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the biodegradable polyester particles and/or may prevent or slow discoloration (e.g., yellowing) of the biodegradable polyester particles by preventing or slowing oxidation of the biodegradable polyester particles. The antioxidant may be selected to minimize discoloration. Examples of suitable antioxidants include hindered phenols, phosphites, and organic sulfites. The antioxidant may be in the form of fine particles (e.g., having an average particle size of 5 μm or less) that are dry blended with the biodegradable polyester particles. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

3D Printing Kits

Examples of the build material composition disclosed herein may be included in a 3D printing kit. In an example, the 3D printing kit includes a build material composition including the biodegradable polyester particles having a volume-based particle size distribution including D10 ranging from about 65 μm to about 85 μm, D50 ranging from about 125 μm to about 145 μm, and D90 ranging from about 225 μm to about 245 μm; and a fusing agent including an energy absorber dissolved or dispersed in a liquid vehicle.

Any example of the build material composition may be used in the 3D printing kit.

In other examples, the 3D printing kit may include the build material composition, the fusing agent, and a detailing agent. In still other examples, the 3D printing kit may include the build material composition, the fusing agent, and a coloring agent. In yet further examples, the 3D printing kit may include the build material composition, the fusing agent, the detailing agent, and the coloring agent.

As used herein, it is to be understood that the terms “material set” or “kit” may, in some instances, be synonymous with “composition.” Further, “material set” and “kit” are understood to be compositions comprising one or more components where the different components in the compositions are each contained in one or more containers, separately or in any combination, prior to and during printing but these components can be combined together during printing. The containers can be any type of a vessel, box, or receptacle made of any material.

As mentioned above, various agents may be included in the 3D printing kits disclosed herein. Example compositions of the fusing agent, the detailing agent, and the coloring agent will now be described.

Fusing Agent

As mentioned herein, in examples of the 3D printing kit and/or the 3D printing method disclosed herein, a fusing agent may be used. Also as mentioned, the fusing agent includes an energy absorber dissolved or dispersed in a liquid vehicle.

Enemy Absorbers

In some examples, the energy absorber may have substantial absorption (e.g., 80%) at least in the visible region (400 nm-780 nm) and may also absorb energy in the infrared region (e.g., 800 nm to 4000 nm). In other examples, the energy absorber may have absorption at wavelengths ranging from 800 nm to 4000 nm and have transparency at wavelengths ranging from 400 nm to 780 nm. As used herein, “absorption” means that at least 80% of radiation having wavelengths within the specified range is absorbed. Also as used herein, “transparency” means that 25% or less of radiation having wavelengths within the specified range is absorbed.

In some examples, the energy absorber may be an infrared light absorbing colorant. In an example, the energy absorber is a near-infrared light absorbing colorant. Any near-infrared colorants, e.g., those produced by Fabricolor, Eastman Kodak, or BASF, Yamamoto, may be used in the fusing agent. As one example, the fusing agent may be a printing liquid formulation including carbon black as the energy absorber. Examples of this printing liquid formulation are commercially known as CM997A, 516458, C18928, C93848, C93808, or the like, all of which are available from HP Inc.

As another example, the fusing agent may be a printing liquid formulation including near-infrared absorbing dyes as the energy absorber. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

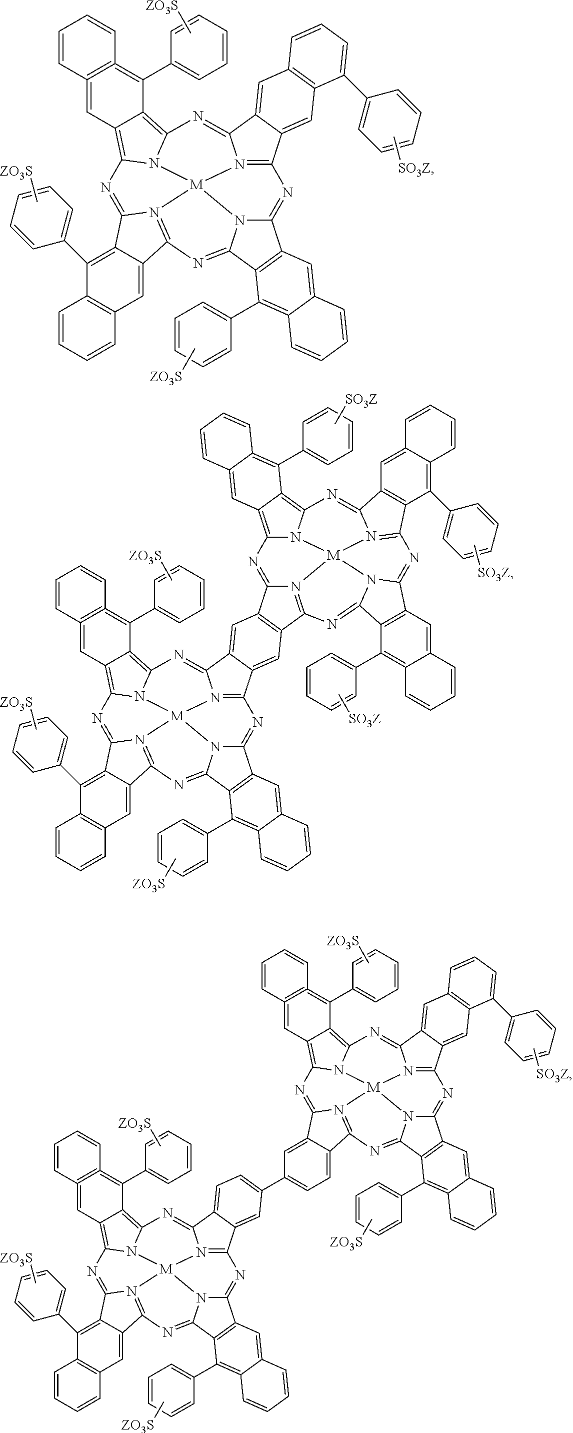

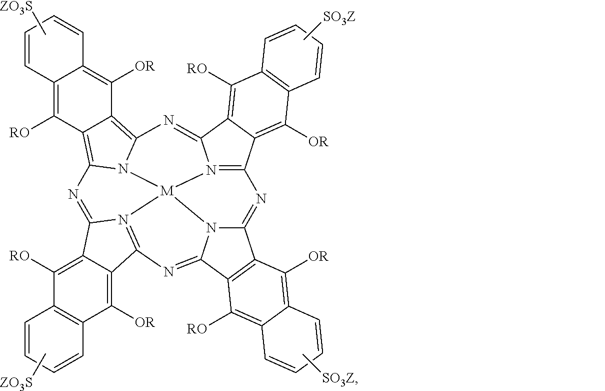

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

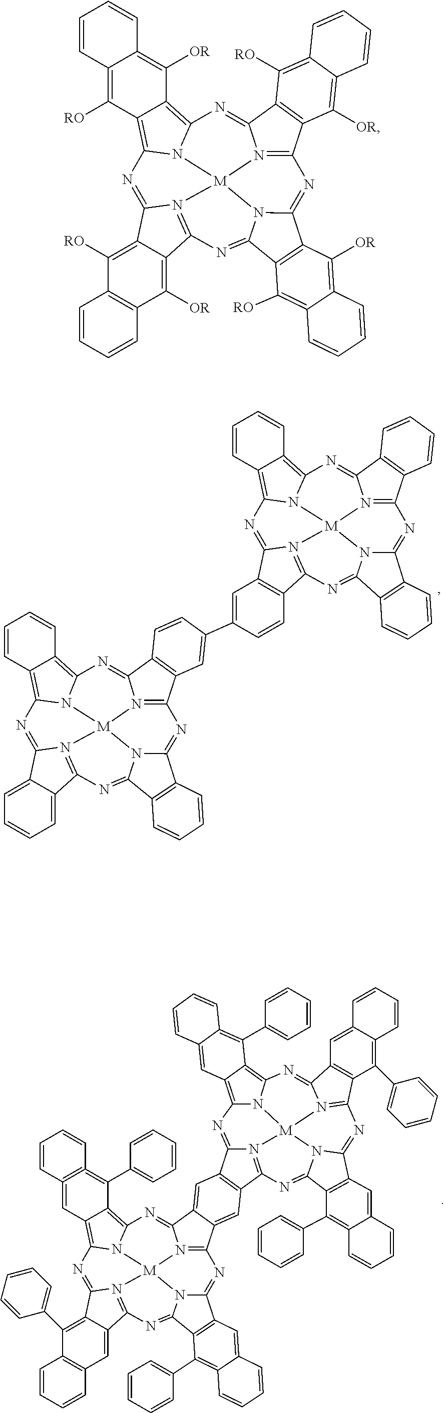

and mixtures thereof. For the hydrophobic near-infrared absorbing dyes, M can be a divalent metal atom (e.g., copper, etc.) or can include a metal that has Cl, Br, or OR′ (R′=H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthroquinone dyes or pigments and metal (e.g., nickel) dithiolene dyes or pigments may have the following structures, respectively:

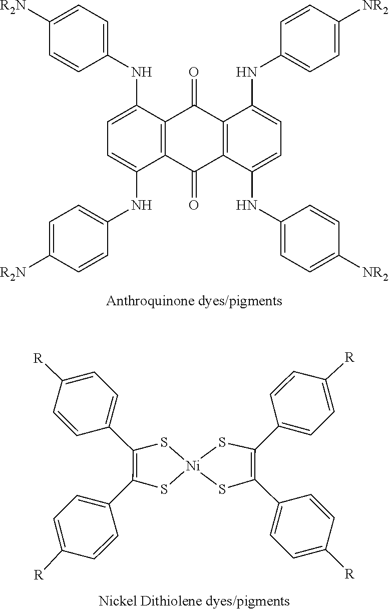

where R in the anthroquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

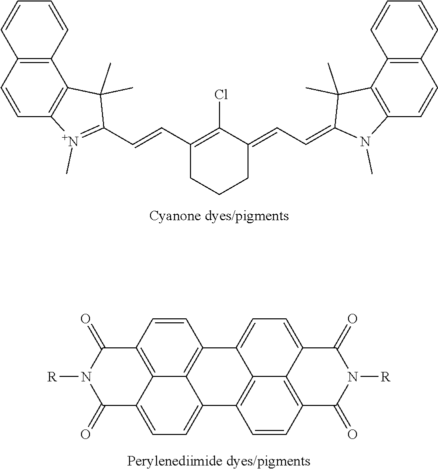

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

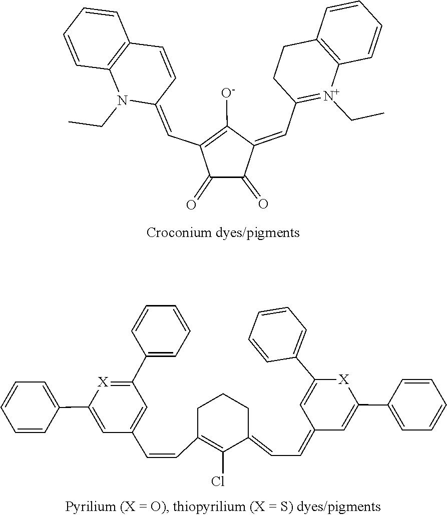

Boron-dipyrromethene dyes or pigments and aza-boron-dipyrromethene dyes or pigments may have the following structures, respectively:

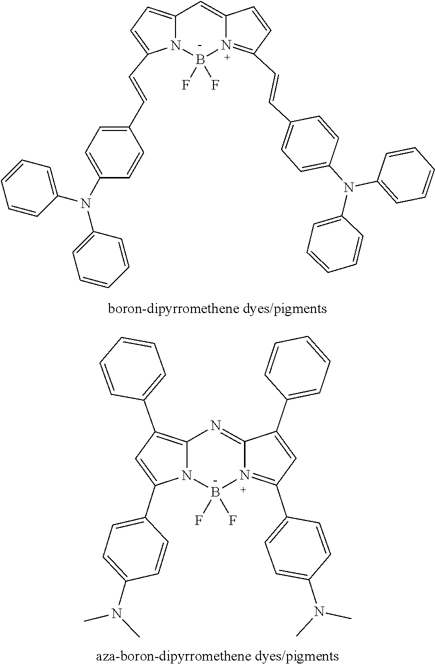

Other suitable near-infrared absorbing dyes may include aminium dyes, tetraaryldiamine dyes, phthalocyanine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

In other examples, the energy absorber may be the energy absorber that has absorption at wavelengths ranging from 800 nm to 4000 nm and transparency at wavelengths ranging from 400 nm to 780 nm. The absorption of this energy absorber is the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the fusing agent to be inkjet jettable as well as electromagnetically selective (e.g., having absorption at wavelengths ranging from 800 nm to 4000 nm and transparency at wavelengths ranging from 400 nm to 780 nm).

In an example, this energy absorber has an average particle diameter (e.g., volume-weighted mean diameter) ranging from greater than 0 nm to less than 220 nm. In another example, the energy absorber has an average particle diameter ranging from greater than 0 nm to 120 nm. In still another example, the energy absorber has an average particle diameter ranging from about 10 nm to about 200 nm.

In an example, this energy absorber is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

Still other examples of the energy absorber absorb at least some of the wavelengths within the range of 400 nm to 4000 nm. Examples include glass fibers, titanium dioxide, clay, mica, talc, barium sulfate, calcium carbonate, phosphate pigments, and/or silicate pigments. These energy absorbers are often white or lightly colored and may be used in either the core fusing agent or the primer fusing agent.

Phosphates may have a variety of counterions, such as copper, zinc, iron, magnesium, calcium, strontium, the like, and combinations thereof. Examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. Silicates can have the same or similar counterions as phosphates. Example silicates can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the phosphates and silicates described herein are not limited to counterions having a +2 oxidation state, and that other counterions can also be used to prepare other suitable near-infrared pigments.

The amount of the energy absorber that is present in the fusing agent ranges from greater than 0 wt % active to about 40 wt % active based on the total weight of the fusing agent. In other examples, the amount of the energy absorber in the fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the fusing agent having jetting reliability and heat and/or radiation absorbance efficiency.

FA Vehicles

As used herein, “FA vehicle” may refer to the liquid in which the energy absorber is dispersed or dissolved to form the fusing agent. A wide variety of FA vehicles, including aqueous and non-aqueous vehicles, may be used in the fusing agent.

The solvent of the fusing agent may be water or a non-aqueous solvent (e.g., ethanol, acetone, n-methyl pyrrolidone, aliphatic hydrocarbons, etc.). In some examples, the fusing agent consists of the energy absorber and the solvent (without other components). In these examples, the solvent makes up the balance of the fusing agent. In other examples, the FA vehicle may include other components, depending, in part, upon the applicator that is to be used to dispense the fusing agent. Examples of other suitable fusing agent components include co-solvent(s), humectant(s), surfactant(s), antimicrobial agent(s), anti-kogation agent(s), and/or chelating agent(s).

When the energy absorber is an inorganic pigment (having absorption at wavelengths ranging from 800 nm to 4000 nm and transparency at wavelengths ranging from 400 nm to 780 nm), the FA vehicle may also include dispersant(s) and/or silane coupling agent(s).

The energy absorber (e.g., the inorganic pigment having absorption at wavelengths ranging from 800 nm to 4000 nm and transparency at wavelengths ranging from 400 nm to 780 nm) may, in some instances, be dispersed with a dispersant. As such, the dispersant helps to uniformly distribute the energy absorber throughout the fusing agent. Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the fusing agent may range from about 10 wt % to about 200 wt % based on the weight of the energy absorber in the fusing agent.

A silane coupling agent may also be added to the fusing agent to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the fusing agent may range from about 0.1 wt % active to about 50 wt % active based on the weight of the energy absorber in the fusing agent. In an example, the total amount of silane coupling agent(s) in the fusing agent ranges from about 1 wt % active to about 30 wt % active based on the weight of the energy absorber. In another example, the total amount of silane coupling agent(s) in the fusing agent ranges from about 2.5 wt % active to about 25 wt % active based on the weight of the energy absorber.

Classes of organic co-solvents that may be used in a water-based fusing agent include aliphatic alcohols, aromatic alcohols, diols, glycol ethers, polyglycol ethers, lactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, N-(2-hydroxyethyl)-2-pyrrolidone, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Some examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the fusing agent in a total amount ranging from about 1 wt % to about 65 wt % based upon the total weight of the fusing agent, depending upon the jetting architecture of the applicator. The biodegradable polyester particles in the build material composition may be susceptible to hydrolysis in the presence of water. As such, in some example, it may be desirable for the fusing agent to include more co-solvent and a reduced amount of water (e.g., 65 wt % or less). As examples, the co-solvent(s) make up about 28 wt % and the water makes up about 65 wt % of the fusing agent, or the co-solvent(s) make up about 38 wt % and the water makes up about 55 wt % of the fusing agent, or the co-solvent(s) make up about 58 wt % and the water makes up about 35 wt % of the fusing agent.

The co-solvent(s) of the fusing agent may also depend, in part, upon the jetting technology that is to be used to dispense the fusing agent. For example, if thermal inkjet printheads are to be used, water and/or ethanol and/or other longer chain alcohols (e.g., pentanol) may be the solvent (i.e., makes up 35 wt % or more of the fusing agent) or co-solvents. For another example, if piezoelectric inkjet printheads are to be used, water may make up from about 25 wt % to about 30 wt % of the fusing agent, and the solvent (i.e., 35 wt % or more of the fusing agent) may be ethanol, isopropanol, acetone, etc.

The FA vehicle may also include humectant(s). In an example, the total amount of the humectant(s) present in the fusing agent ranges from about 3 wt % active to about 10 wt % active, based on the total weight of the fusing agent. An example of a suitable humectant is ethoxylated glycerin having the following formula:

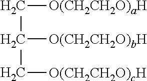

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In some examples, the FA vehicle includes surfactant(s) to improve the jettability of the fusing agent. Examples of suitable surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), and combinations thereof. In other examples, the surfactant is an ethoxylated low-foam wetting agent (e.g., SURFYNOL® 440 or SURFYNOL® CT-111 from Evonik Degussa) or an ethoxylated wetting agent and molecular defoamer (e.g., SURFYNOL® 420 from Evonik Degussa). Still other suitable surfactants include non-ionic wetting agents and molecular defoamers (e.g., SURFYNOL® 104E from Evonik Degussa) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (an organic surfactant available from Evonik Degussa). Yet another suitable surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants is used, the total amount of surfactant(s) in the fusing agent may range from about 0.01 wt % active to about 10 wt % active based on the total weight of the fusing agent. In an example, the total amount of surfactant(s) in the fusing agent may be about 0.75 wt % active based on the total weight of the fusing agent.

An anti-kogation agent may be included in the fusing agent that is to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS® O3A or CRODAFOS® N-3 acid from Croda), dextran 500 k, CRODAFOS™ HCE (phosphate-ester from Croda Int.), CRODAFOS® N10 (oleth-10-phosphate from Croda Int.), DISPERSOGEN® LFH (polymeric dispersing agent with aromatic anchoring groups, acid form, anionic, from Clariant), or a combination of oleth-3-phosphate and a low molecular weight (e.g., <5,000) acrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the fusing agent may range from greater than 0.10 wt % active to about 1.5 wt % active based on the total weight of the fusing agent. In an example, the oleth-3-phosphate is included in an amount ranging from about 0.20 wt % active to about 0.60 wt % active.

The FA vehicle may also include antimicrobial agent(s). Suitable antimicrobial agents include biocides and fungicides. Example antimicrobial agents may include the NUOSEPT™ (Troy Corp.), UCARCIDE™ (The Dow Chemical Company), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from The Dow Chemical Company).

In an example, the fusing agent may include a total amount of antimicrobial agents that ranges from about 0.0001 wt % active to about 1 wt % active. In an example, the antimicrobial agent(s) is/are a biocide(s) and is/are present in the fusing agent in an amount ranging from about 0.25 wt % active to about 0.3 wt % active (based on the total weight of the fusing agent).

Chelating agents (or sequestering agents) may be included in the FA vehicle to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the fusing agent may range from greater than 0 wt % active to about 2 wt % active based on the total weight of the fusing agent. In an example, the chelating agent(s) is/are present in the fusing agent in an amount of about 0.08 wt % active (based on the total weight of the fusing agent).

The balance of the fusing agent is water (e.g., deionized water, purified water, etc.), which as described herein, may vary depending upon the other components in the fusing agent. In one example, the fusing agent is jettable via a thermal inkjet printhead, and includes from about 30 wt % to about 55 wt % water.

Detailing Agent

In some examples of the 3D printing kit and/or the 3D printing method disclosed herein, a detailing agent may be used. The detailing agent may include a surfactant, a co-solvent, and a balance of water. In some examples, the detailing agent consists of these components, and no other components. In some other examples, the detailing agent may further include a colorant. In still some other examples, detailing agent consists of a colorant, a surfactant, a co-solvent, and a balance of water, with no other components. In yet some other examples, the detailing agent may further include additional components, such as anti-kogation agent(s), antimicrobial agent(s), and/or chelating agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % to about 5.00 wt % with respect to the total weight of the detailing agent.

The co-solvent(s) that may be used in the detailing agent include any of the co-solvents listed above in reference to the fusing agent. The total amount of co-solvent(s) in the detailing agent may range from about 1.00 wt % to about 65.00 wt % with respect to the total weight of the detailing agent. A reduced amount of water may be desirable for the detailing agent to reduce hydrolysis of the biodegradable polyester particles in the build material composition.

In some examples, the detailing agent does not include a colorant. In these examples, the detailing agent may be colorless. As used herein, “colorless,” means that the detailing agent is achromatic and does not include a colorant.

When the detailing agent includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the active (energy absorbing) material in the fusing agent, which absorbs wavelengths within the near-infrared spectrum. As such, the colorant in the detailing agent will not substantially absorb the fusing radiation, and thus will not initiate melting and fusing (coalescence) of the build material composition in contact therewith when the build material layer is exposed to the energy.

It may be desirable to add color to the detailing agent when the detailing agent is applied to the edge of a colored part. Color in the detailing agent may be desirable when used at a part edge because some of the colorant may become embedded in the build material that fuses/coalesces at the edge. As such, in some examples, the dye in the detailing agent may be selected so that its color matches the color of the active material in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

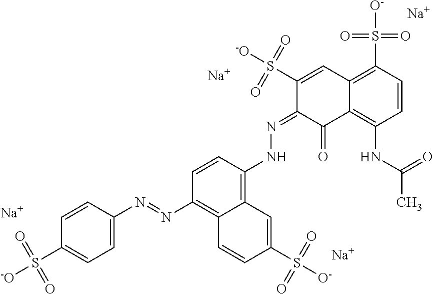

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

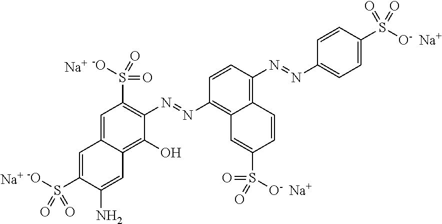

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

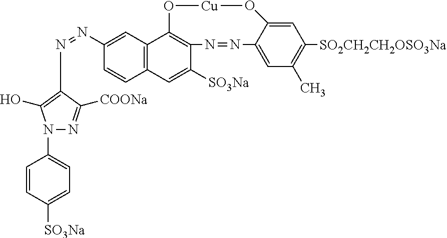

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

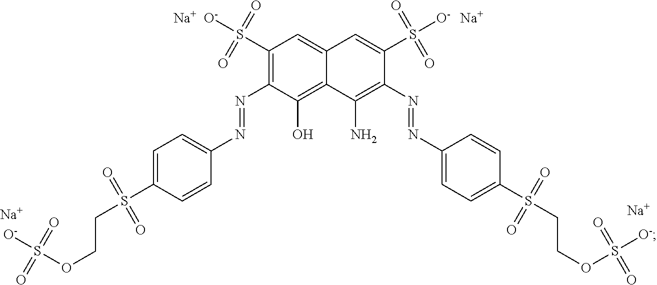

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D part.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

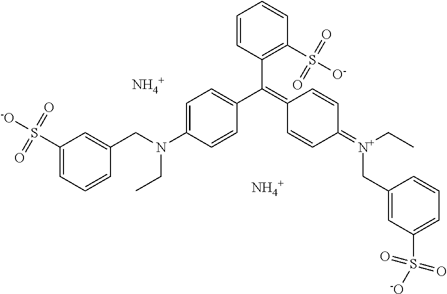

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

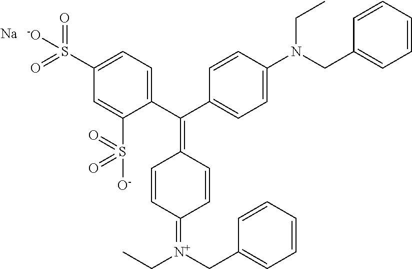

(commercially available as Acid Blue 7); and a phthalocyanine with a chemical structure of:

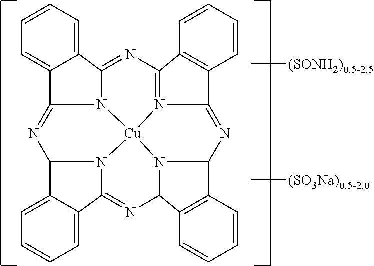

(commercially available as Direct Blue 199); and combinations thereof.

In an example of the detailing agent, the dye may be present in an amount ranging from about 1.00 wt % to about 3.00 wt % based on the total weight of the detailing agent. In another example of the detailing agent including a combination of dyes, one dye (e.g., the black dye) is present in an amount ranging from about 1.50 wt % to about 1.75 wt % based on the total weight of the detailing agent, and the other dye (e.g., the cyan dye) is present in an amount ranging from about 0.25 wt % to about 0.50 wt % based on the total weight of the detailing agent.

The balance of the detailing agent is water. As such, the amount of water may vary depending upon the amounts of the other components that are included.

Coloring Agent

In any the examples of the 3D printing kit and/or the 3D printing method disclosed herein, a coloring agent may be used. The coloring agent may include a colorant, a co-solvent, and a balance of water. In some examples, the coloring agent consists of these components, and no other components. In some other examples, the coloring agent may further include a binder (e.g., an acrylic latex binder, which may be a copolymer of any two or more of styrene, acrylic acid, methacrylic acid, methyl methacrylate, ethyl methacrylate, and butyl methacrylate) and/or a buffer. In still other examples, the coloring agent may further include additional components, such as dispersant(s), humectant(s), surfactant(s), anti-kogation agent(s), antimicrobial agent(s), and/or chelating agent(s) (each of which is described herein in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

In some instances, the colorant of the coloring agent may be transparent to infrared wavelengths. In other instances, the colorant of the coloring agent may not be completely transparent to infrared wavelengths, but does not absorb enough radiation to sufficiently heat the build material composition in contact therewith. In an example, the colorant absorbs less than 10% of radiation having wavelengths in a range of 650 nm to 2500 nm. In another example, the colorant absorbs less than 20% of radiation having wavelengths in a range of 650 nm to 4000 nm.

The colorant of the coloring agent is also capable of absorbing radiation with wavelengths of 650 nm or less. As such, the colorant absorbs at least some wavelengths within the visible spectrum, but absorbs little or no wavelengths within the near-infrared spectrum. This is in contrast to at least some examples of the energy absorber in the fusing agent, which absorbs wavelengths within the near-infrared spectrum and/or the infrared spectrum. As such, the colorant in the coloring agent will not substantially absorb the fusing radiation, and thus will not initiate coalescing/fusing of the build material composition in contact therewith when the build material composition is exposed to energy.

Examples of IR transparent colorants include acid yellow 23 (AY 23), AY17, acid red 52 (AR 52), AR 289, and reactive red 180 (RR 180). Examples of colorants that absorb some visible wavelengths and some IR wavelengths include cyan colorants, such as direct blue 199 (DB 199) and pigment blue 15:3 (PB 15:3).

In other examples, the colorant may be any azo dye having sodium or potassium counter ion(s) or any diazo (i.e., double azo) dye having sodium or potassium counter ion(s), such as those described herein for the detailing agent.

An example of the pigment based coloring agent may include from about 1 wt % to about 10 wt % of pigment(s), from about 10 wt % to about 30 wt % of co-solvent(s), from about 1 wt % to about 10 wt % of dispersant(s), from about 0.1 wt % to about 5 wt % of binder(s), from 0.01 wt % to about 1 wt % of anti-kogation agent(s), from about 0.05 wt % to about 0.1 wt % antimicrobial agent(s), and a balance of water. An example of the dye based coloring agent may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents 18 include C9384A (printhead HP 72), C9383A (printhead HP 72), C4901A (printhead HP 940), and C4900A (printhead HP 940).

Printing Methods and Methods of Use

Referring now to FIG. 2, an example a method 200 for 3D printing is depicted. The examples of the method 200 may use an example of the 3D printing kit disclosed herein.

As shown in FIG. 2, the method 200 for three-dimensional (3D) printing comprises: spreading a build material composition to form a build material layer, the build material composition including: biodegradable polyester particles having a volume-based particle size distribution including D10 ranging from about 65 μm to about 85 μm, D50 ranging from about 125 μm to about 145 μm, and D90 ranging from about 225 μm to about 245 μm and a flow aid in an amount ranging from greater than 0 wt % to less than 5 wt %, based upon a total weight of the build material composition (reference numeral 202); based on a 3D object model, selectively applying a fusing agent on at least a portion of the build material layer (reference numeral 204); and exposing the build material layer to electromagnetic radiation to coalesce the build material composition in the at least the portion, thereby forming a layer of a 3D object (reference numeral 206).

While not shown, the method 200 may include preparing the build material composition. Build material composition may be accomplished using the method 100 shown in FIG. 1.

Furthermore, prior to execution of the method 200, it is to be understood that a controller may access data stored in a data store pertaining to a 3D object that is to be printed. For example, the controller may determine the number of layers of the build material composition that are to be formed, the locations at which any of the agents is/are to be deposited on each of the respective layers, etc.

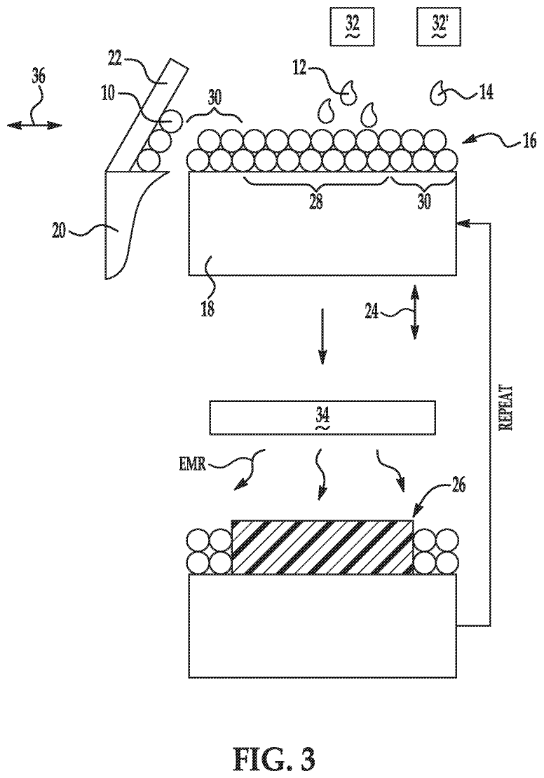

Referring now to FIG. 3, an example of the method 200, which utilizes the build material composition 10 (including at least the biodegradable polyester particles and the flow aid), the fusing agent 12 and the detailing agent 14 is graphically depicted.

In FIG. 3, a layer 16 of the build material composition 10 is applied on a build area platform 18. A printing system may be used to apply the build material composition 10. The printing system may include the build area platform 18, a build material supply 20 containing the build material composition 10, and a build material distributor 22.

The build area platform 18 receives the build material composition 10 from the build material supply 20. The build area platform 18 may be moved in the directions as denoted by the arrow 24, e.g., along the z-axis, so that the build material composition 10 may be delivered to the build area platform 18 or to a previously formed layer. In an example, when the build material composition 10 is to be delivered, the build area platform 18 may be programmed to advance (e.g., downward) enough so that the build material distributor 22 can push the build material composition 10 onto the build area platform 18 to form a substantially uniform layer of the build material composition 10 thereon. The build area platform 18 may also be returned to its original position, for example, when a new part is to be built.

The build material supply 20 may be a container, bed, or other surface that is to position the build material composition 10 between the build material distributor 22 and the build area platform 18. The build material supply 20 may include heaters so that the build material composition 10 is heated to a supply temperature ranging from about 25° C. to about 150° C. In these examples, the supply temperature may depend, in part, on the build material composition 10 used and/or the 3D printer used. As such, the range provided is one example, and higher or lower temperatures may be used.

The build material distributor 22 may be moved in the directions as denoted by the arrow 36, e.g., along the y-axis, over the build material supply 20 and across the build area platform 18 to spread the layer 16 of the build material composition 10 over the build area platform 18. The build material distributor 22 may also be returned to a position adjacent to the build material supply 20 following the spreading of the build material composition 10. The build material distributor 22 may be a blade (e.g., a doctor blade), a roller, a combination of a roller and a blade, and/or any other device capable of spreading the build material composition 10 over the build area platform 18. For instance, the build material distributor 22 may be a counter-rotating roller. In some examples, the build material supply 20 or a portion of the build material supply 20 may translate along with the build material distributor 22 such that build material composition 10 is delivered continuously to the build material distributor 22 rather than being supplied from a single location at the side of the printing system as depicted in FIG. 3.

The build material supply 20 may supply the build material composition 10 into a position so that it is ready to be spread onto the build area platform 18. The build material distributor 22 may spread the supplied build material composition 10 onto the build area platform 18. The controller (not shown) may process “control build material supply” data, and in response, control the build material supply 20 to appropriately position the particles of the build material composition 10, and may process “control spreader” data, and in response, control the build material distributor 22 to spread the build material composition 10 over the build area platform 18 to form the layer 16 of the build material composition 10 thereon. In FIG. 3, one build material layer 16 has been formed.

The layer 16 has a substantially uniform thickness across the build area platform 18. In an example, the build material layer 16 has a thickness ranging from about 50 μm to about 950 μm. In another example, the thickness of the build material layer 16 ranges from about 30 μm to about 300 μm. It is to be understood that thinner or thicker layers may also be used. For example, the thickness of the build material layer 16 may range from about 20 μm to about 500 μm. The layer thickness may be about 2× (i.e., 2 times) the average diameter of the biodegradable polyester particles at a minimum for finer part definition. In some examples, the layer 16 thickness may be about 1.2× the average diameter of the biodegradable polyester particles.

After the build material composition 10 has been applied, and prior to further processing, the build material layer 16 may be exposed to pre-heating. In an example, the pre-heating temperature may be below the melting point of the biodegradable polyester particles of the build material composition 10. As examples, the pre-heating temperature may range from about 5° C. to about 50° C. below the melting point of the biodegradable polyester material. In an example, the pre-heating temperature ranges from about 50° C. to about 205° C. In still another example, the pre-heating temperature ranges from about 100° C. to about 190° C. The low pre-heating temperature may enable the non-patterned build material composition 10 to be easily removed from the 3D object after completion of the 3D object. In these examples, the pre-heating temperature may depend, in part, on the build material composition 10 used. As such, the ranges provided are some examples, and higher or lower temperatures may be used.

Pre-heating the layer 16 may be accomplished by using any suitable heat source that exposes all of the build material composition 10 in the layer 16 to the heat. Examples of the heat source include a thermal heat source (e.g., a heater (not shown) integrated into the build area platform 18 (which may include sidewalls)) or a radiation source 34.

After the layer 16 is formed, and in some instances is pre-heated, the fusing agent 12 is selectively applied on at least some of the build material composition 10 in the layer 16.

To form a layer 26 of a 3D object, at least a portion (e.g., portion 28) of the layer 16 of the build material composition 10 is patterned with the fusing agent 12. The volume of the fusing agent 12 that is applied per unit of the build material composition 10 in the patterned portion 28 may be sufficient to absorb and convert enough electromagnetic radiation so that the build material composition 10 in the patterned portion 28 will coalesce/fuse. The volume of the fusing agent 12 that is applied per unit of the build material composition 10 may depend, at least in part, on the energy absorber used, the energy absorber loading in the fusing agent 12, and the build material composition 10 used.

The fusing agent 12 may be formulated to reduce hydrolysis of the biodegradable polyester particles. Some examples of the method 200 include reducing hydrolysis of the biodegradable polyester particles during the three-dimensional printing method by utilizing the fusing agent 12 having a water content ranging from 30 wt % to about 65 wt % of a total weight of the fusing agent 12.

The portion(s) 30 are not patterned with the fusing agent 12 and thus are not to become part of the final 3D object layer 26. In one example of the method 100, no agents are applied on the portion(s) 30.

In the example of the method 200 shown in FIG. 3, the detailing agent 14 is selectively applied to the portion(s) 30 of the layer 16. The detailing agent 14 may provide an evaporative cooling effect to the build material composition 10 to which it is applied. The evaporative cooling effect of the detailing agent 14 may be used to aid in preventing the build material composition 10 in the portion(s) 30 from coalescing/fusing. The evaporative cooling provided by the detailing agent 14 may remove energy from the portion(s) 30, which may lower the temperature of the build material composition 10 in the portion(s) 30 and prevent the build material composition 10 in the portion(s) 30 from coalescing/fusing. As such, examples of the method 200 may include selectively applying a detailing agent 14 on another portion 30 of the build material layer 16 that is to remain non-coalesced after the electromagnetic radiation exposure.

In examples of the method 200, any of the agents 12, 14 may be dispensed from an applicator 32, 32′. The applicator(s) 32, 32′ may each be a thermal inkjet printhead, a piezoelectric printhead, a continuous inkjet printhead, etc., and the selective application of the agent(s) 12, 30 may be accomplished by thermal inkjet printing, piezo electric inkjet printing, continuous inkjet printing, etc. The controller may process data, and in response, control the applicator(s) 32, 32′ to deposit the agent(s) 12, 14 onto predetermined portion(s) 28, 30 of the build material composition 10. It is to be understood that the applicators 32, 32′ may be separate applicators or a single applicator with several individual cartridges for dispensing the respective agents 12, 14.

It is to be understood that the selective application of the agent(s) 12, 14 may be accomplished in a single printing pass or in multiple printing passes. In some examples, the agent(s) 12, 14 is/are selectively applied in a single printing pass. In some other examples, the agent(s) 12, 14 is/are selectively applied in multiple printing passes. In one of these examples, the number of printing passes ranging from 2 to 4. It may be desirable to apply the agent(s) 12, 14 in multiple printing passes to increase the amount, e.g., of the energy absorber, detailing agent, etc. that is applied to the build material composition 10, to avoid liquid splashing, to avoid displacement of the build material composition 10, etc.

After the agent(s) 12, 14 is/are selectively applied in the specific portion(s) 28, 30 of the layer 16, the entire layer 16 of the build material composition 10 is exposed to electromagnetic radiation (shown as EMR in FIG. 3).

The electromagnetic radiation is emitted from the radiation source 34. The length of time the electromagnetic radiation is applied for, or energy exposure time, may be dependent, for example, on one or more of: characteristics of the radiation source 34; characteristics of the build material composition 10; and/or characteristics of the fusing agent 12.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. It may be desirable to expose the build material composition 10 to electromagnetic radiation in multiple radiation events to counteract a cooling effect that may be brought on by the amount of the fusing agent 12 that is applied to the build material layer 16. Additionally, it may be desirable to expose the build material composition 10 to electromagnetic radiation in multiple radiation events to sufficiently elevate the temperature of the build material composition 10 in the portion(s) 28, without over heating the build material composition 10 in the portion(s) 30.

The fusing agent 12 enhances the absorption of the radiation, converts the absorbed radiation to thermal energy, and promotes the transfer of the thermal heat to the build material composition 10 in contact therewith. In an example, the fusing agent 12 sufficiently elevates the temperature of the build material composition 10 in the portion 28 to a temperature above the melting point of the polyamide material, allowing coalescing/fusing of the build material composition 10 to take place. The application of the electromagnetic radiation forms the 3D object layer 26.

In some examples, the electromagnetic radiation has a wavelength ranging from 800 nm to 4000 nm, or from 800 nm to 1400 nm, or from 800 nm to 1200 nm. Radiation having wavelengths within the provided ranges may be absorbed (e.g., 80% or more of the applied radiation is absorbed) by the fusing agent 12 and may heat the build material composition 10 in contact therewith, and may not be substantially absorbed (e.g., 25% or less of the applied radiation is absorbed) by the build material composition 10 in portion(s) 30.

After the 3D object layer 26 is formed, additional layer(s) may be formed thereon to create an example of the 3D object. To form the next layer, additional build material composition 10 may be applied on the layer 26. The fusing agent 12 is then selectively applied on at least a portion of the additional build material composition 10, according to the 3D object model. The detailing agent 14 may be applied in any area of the additional build material composition 10 where coalescence is not desirable. After the agent(s) 12, 14 is/are applied, the entire layer of the additional build material composition 10 is exposed to electromagnetic radiation in the manner described herein. The application of additional build material composition 10, the selective application of the agent(s) 12, 30 and the electromagnetic radiation exposure may be repeated a predetermined number of cycles to form the final 3D object in accordance with the 3D object model.

As such, examples of the method 200 include iteratively applying individual build material layers 16 of the build material composition 10; based on the 3D object model, selectively applying the fusing agent 12 to at least some of the individual build material layers 16 to define individually patterned layers; and iteratively exposing the individually patterned layers to the electromagnetic radiation to form individual object layers 26.

The build material composition 10 that does not become part of the 3D object (e.g., the build material composition in portion(s) 32) may be reclaimed to be reused as build material in the printing of another 3D object.

To impart color to the 3D object, the coloring agent may be applied with the fusing agent and/or on the outermost layer after the 3D object is formed. In these examples, the fusing agent may include an energy absorber that is clear or slightly tinted (e.g., the energy absorber that has absorption at wavelengths ranging from 800 nm to 4000 nm and transparency at wavelengths ranging from 400 nm to 780 nm).

In any of the examples of the method 100 disclosed herein, differently shaped objects may be printed in different orientations within the printing system. As such, while the object may be printed from the bottom of the object to the top of the object, it may alternatively be printed starting with the top of the object to the bottom of the object, or from a side of the object to another side of the object, or at any other orientation that is suitable or desired for the particular geometry of the part being formed.

To further illustrate the present disclosure, examples are given herein. It is to be understood that these examples are provided for illustrative purposes and are not to be construed as limiting the scope of the present disclosure.

### Examples

Ground polylactide was used as the biodegradable polyester. The volume distribution included D10 about 73 μm, D50 about 138 μm, and D90 about 231 μm.

Spreading was attempted with the ground polylactide without any added flow aid. The ground polylactide was not able to be spread into a substantially uniform layer.

About 0.05 wt % of a flow aid (AEROXIDE® 200) was added to the ground polylactide and the composition was mixed. This build material composition was able to be spread into a substantially uniform layer.

Some of the build material composition was printed in accordance with the 3D printing process disclosed herein to form example 3D objects. Specifically, three 3D objects were printed on a small testbed 3D printer (bed temp 135° C.) with an example fusing agent (2 printing passes) that included carbon black as the energy absorber.

Each of the example 3D objects was sufficiently fused/coalesced. Further, the non-patterned build material adjacent to each of the 3D objects was able to be removed and separated from the completed 3D object. Thus, the build material composition including ground polylactide and flow aid was shown to be a suitable build material composition for the 3D printing methods disclosed herein (which utilize a fusing agent).

Because biodegradable polyester is often injection molded, polylactide pellets (not ground and mixed with flow aid) were injection molded to form three comparative 3D objects.

The ultimate tensile strength, elongation at break, and Young's Modulus of each of the example and comparative 3D objects were measured using Instron testing equipment. Table 1 shows the average results for the three example 3D objects and the three comparative example 3D objects.

TABLE 1

| | Avg. Ultimate | | |
|---|---|---|---|
| | Tensile | Avg. Elongation | Avg. Young's |
| 3D Object ID | Strength (MPa) | at Break (%) | Modulus (MPa) |
| Ex. Objects - | 39 | 1.3 | 4300 |
| 3D printed | | | |
| Comp. Objects - | 57 | 2.9 | 3700 |
| Injection molded | | | |

As shown in Table 1, the average Young's Modulus was higher for the example 3D objects compared to the injection molded comparative objects. As such, the example 3D objects were stiffer than the injection molded comparative objects. The elongation at break and ultimate tensile strength of the example 3D objects were slightly lower than the injection molded comparative objects, but altering print conditions can increase these properties.

The example 3D objects also had better resolution and better aesthetics than the injection molded comparative objects.

It is to be understood that the ranges provided herein include the stated range and any value or sub-range within the stated range, as if such values or sub-ranges were explicitly recited. For example, from about 30 wt % to about 55 wt % should be interpreted to include not only the explicitly recited limits of from about 30 wt % to about 55 wt %, but also to include individual values, such as about 33 wt %, about 40.75 wt %, about 45 wt %, about 51.5 wt %, etc., and sub-ranges, such as from about 36 wt % to about 46 wt %, from about 32.65 wt % to about 52.55 wt %, from about 38 wt % to about 48 wt %, etc.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. As an example, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing kit, comprising:
a build material composition including biodegradable polyester particles having a volume-based particle size distribution including D10 ranging from about 65 μm to about 85 μm, D50 ranging from about 125 μm to about 145 μm, and D90 ranging from about 225 μm to about 245 μm; and
a fusing agent including an energy absorber dissolved or dispersed in a liquid vehicle.

2. The 3D printing kit as defined in claim 1 wherein the volume-based particle size distribution is at least substantially bi-modal.

3. The 3D printing kit as defined in claim 1 wherein the build material composition further comprises a flow aid.

4. The 3D printing kit as defined in claim 3 wherein the build material composition includes from greater than 95 wt % to less than 100 wt % of the biodegradable polyester particle and from greater than 0 wt % to less than 5 wt % of the flow aid.

5. The 3D printing kit as defined in claim 1 wherein the biodegradable polyester particles are selected from the group consisting of polylactic acid, polyglycolide, poly(DL-lactide-co-glycolide), polyethylene succinate, polybutylene succinate, polybutylene adipate, polybutylene succinate/adipate copolymer, polycaprolactone, and combinations thereof.

6. The 3D printing kit as defined in claim 1 wherein the fusing agent is jettable via a thermal inkjet printhead, and includes from about 30 wt % to about 55 wt % water.

7. The 3D printing kit as defined in claim 1 wherein a volume weighted mean diameter of the biodegradable polyester particles ranges from about 25 μm to about 475 μm.

8. A three-dimensional printing method, comprising:
spreading a build material composition to form a build material layer, the build material composition including:
biodegradable polyester particles having a volume-based particle size distribution including D10 ranging from about 65 μm to about 85 μm, D50 ranging from about 125 μm to about 145 μm, and D90 ranging from about 225 μm to about 245 μm; and
a flow aid in an amount ranging from greater than 0 wt % to less than 5 wt %, based upon a total weight of the build material composition;
based on a 3D object model, selectively applying a fusing agent on at least a portion of the build material layer; and
exposing the build material layer to electromagnetic radiation to coalesce the build material composition in the at least the portion, thereby forming a layer of a 3D object.

9. The method as defined in claim 8, further comprising:
iteratively applying individual build material layers of the build material composition;
based on the 3D object model, selectively applying the fusing agent to at least some of the individual build material layers to define individually patterned layers; and
iteratively exposing the individually patterned layers to the electromagnetic radiation to form individual object layers.

10. The method as defined in claim 8, further comprising selectively applying a detailing agent on an other portion of the build material layer that is to remain non-coalesced after the electromagnetic radiation exposure.

11. The method as defined in claim 8 wherein the biodegradable polyester particles are selected from the group consisting of polylactic acid, polyglycolide, poly(DL-lactide-go-glycolide), polyethylene succinate, polybutylene succinate, polybutylene adipate, polybutylene succinate/adipate copolymer, polycaprolactone, and combinations thereof.

12. The method as defined in claim 8, further comprising reducing hydrolysis of the biodegradable polyester particles during the three-dimensional printing method by utilizing the fusing agent having a water content ranging from 30 wt % to about 65 wt % of a total weight of the fusing agent.

13. A method for preparing a build material composition for a fusing agent based three-dimensional printing technique, the method comprising:
grinding biodegradable polyester pellets to form biodegradable polyester particles having a volume-based particle size distribution including D10 ranging from about 65 μm to about 85 μm, D50 ranging from about 125 μm to about 145 μm, and D90 ranging from about 225 μm to about 245 μm; and
adding a flow aid to the biodegradable polyester particles so that the flow aid is present in an amount ranging from greater than 0 wt % to less than 5 wt %, based upon a total weight of the build material composition.

14. The method as defined in claim 13, further comprising monitoring the volume-based particle size distribution throughout the grinding process.

15. The method as defined in claim 13 wherein the biodegradable polyester particles have a reduction in crystallinity relative to the biodegradable polyester pellets.
